(19) United States
(12) Patent Application Publication
(10) Pub. No.: US 2025/0220765 A1
(43) Pub. Date: Jul. 3, 2025

(54) SYSTEMS AND METHODS FOR ADAPTIVE WAKE-UP SIGNAL (WUS) AND CONNECTED-MODE DISCONTINUOUS RECEPTION (C-DRX) SKIPPING

(71) Applicant: Meta Platforms Technologies, LLC, Menlo Park, CA (US)

(72) Inventors: Surendra Boppana, Bothell, WA (US); Zhu Ji, Cupertino, CA (US); Madhusudan Kinthada Venkata, South San Diego, CA (US); Yee Sin Chan, San Francisco, CA (US)

(73) Assignee: Meta Platforms Technologies, LLC, Menlo Park, CA (US)

(21) Appl. No.: 18/398,778

(22) Filed: Dec. 28, 2023

Related U.S. Application Data
(60) Provisional application No. 63/442,944, filed on Feb. 2, 2023.

(51) Int. Cl. H04W 76/28; H04W 24/08; H04W 52/02

(52) U.S. Cl. CPC H04W 76/28; H04W 24/08; H04W 52/0229

(57) ABSTRACT

Systems and methods of adaptive wake-up signal (WUS) and connected-mode discontinuous reception (C-DRX) skipping may include a wireless communication device which establishes a connection between the wireless communication device and a wireless communication node. The connection may be established according to a discontinuous reception (DRX) configuration defined by the wireless communication node. The DRX configuration may include an on period and a sleep period of a DRX cycle. The wireless communication device may determine one or more metrics of the wireless communication device or the connection. The wireless communication device may increase a duration of the sleep period within the DRX cycle of the connection according to the one or more metrics.

### CROSS-REFERENCE TO RELATED PATENT APPLICATIONS

The present application claims the benefit of and priority to U.S. Provisional Application No. 63/442,944, filed Feb. 2, 2023, the disclosure of which is incorporated herein by reference in its entirety.

### FIELD OF DISCLOSURE

The present disclosure is generally related to wireless communication between devices, including but not limited to, systems and methods for adaptive wake-up signal (WUS) and connected-mode discontinuous reception (C-DRX) skipping.

### BACKGROUND

Augmented reality (AR), virtual reality (VR), and mixed reality (MR) are becoming more prevalent, which such technology being supported across a wider variety of platforms and device. Some AR/VR/MR devices may communicate via cellular connections with various cellular equipment/cell sites/base stations. Such communications may be configured according to a discontinuous reception (DRX) configuration.

### SUMMARY

In one aspect, this disclosure is directed to a method. The method may include establishing, by a wireless communication device, a connection between the wireless communication device and a wireless communication node. The connection may be established according to a discontinuous reception (DRX) configuration defined by the wireless communication node. The DRX configuration may include/define/specify/describe/indicate an on period and a sleep period of a DRX cycle. The method may include determining, by the wireless communication device, one or more metrics of the wireless communication device or the connection. The method may include increasing, by the wireless communication device, a duration of the sleep period within the DRX cycle of the connection according to the one or more metrics.

In some embodiments, the DRX configuration includes (e.g., indicates, specifies, identifies, establishes or configures) a wake-up signal (WUS) period in which the wireless communication device is to listen for a WUS from the wireless communication node; and increasing the duration of the sleep period includes maintaining, by the wireless communication device, a state of the wireless communication device in a sleep mode during the WUS period according to the one or more metrics. In some embodiments, increasing the duration of the sleep period includes switching, by the wireless communication device, a state of the wireless communication device to a sleep mode during a portion of the on period of the DRX cycle according to the one or more metrics. In some embodiments, increasing the duration of the sleep period includes switching, by the wireless communication device, a state of the wireless communication device to a sleep mode for a full duration of the on period of the DRX cycle according to the one or more metrics. In some embodiments, the one or more metrics include configuration information of the DRX configuration.

In some embodiments, the configuration information of the DRX configuration includes (e.g., indicates, specifies, identifies, establishes or configures) at least one of a first duration between a wake-up signal (WUS) period and the on period of the DRX cycle, a second duration of the WUS period, a third duration of the on period, a periodicity of the on period, or a value of an inactivity timer. In some embodiments, the one or more metrics include (e.g., indicate, specify, identify, describe, establish or configure) one or more traffic patterns on the connection. In some embodiments, the one or more traffic patterns include (e.g., indicate, specify, identify, describe, establish or configure) at least one of a buffer status, a channel quality indicator (CQI), a retransmission prediction, a traffic type, or a prediction of a physical downlink control channel (PDCCH) message or physical downlink shared channel (PDSCH) message. In some embodiments, the one or more metrics include one or more power or thermal metrics of a device including the wireless communication device. In some embodiments, the one or more power or thermal metrics include at least one of a battery level, a state of charge of a battery of the device, a rate of change of the battery level, a temperature, or a rate of change of the temperature of the device.

In another aspect, this disclosure is directed to a wireless communication device. The wireless communication device may include a transceiver. The wireless communication device may include one or more processors configured to establish a connection between the wireless communication device and a wireless communication node. The connection may be established according to a discontinuous reception (DRX) configuration defined by the wireless communication node. The DRX configuration may include/describe/specify/establish/indicate an on period and a sleep period of a DRX cycle. The one or more processors may be configured to determine one or more metrics of the wireless communication device or the connection. The processors may be configured to increase a duration of the sleep period within the DRX cycle of the connection according to the one or more metrics.

In some embodiments, the DRX configuration includes (e.g., indicates, specifies, identifies, establishes or configures) a wake-up signal (WUS) period in which the wireless communication device is to listen for a WUS from the wireless communication node; and increasing the duration of the sleep period includes maintaining a state of the wireless communication device in a sleep mode during the WUS period according to the one or more metrics. In some embodiments, increasing the duration of the sleep period includes switching a state of the wireless communication device to a sleep mode during a portion of the on period of the DRX cycle according to the one or more metrics or switching the state of the wireless communication device to the sleep mode for a full duration of the on period of the DRX cycle according to the one or more metrics. In some embodiments, the one or more metrics include configuration information of the DRX configuration.

In some embodiments, the configuration information of the DRX configuration includes (e.g., indicates, specifies, identifies, establishes or configures) at least one of a first duration between a wake-up signal (WUS) period and the on period of the DRX cycle, a second duration of the WUS period, a third duration of the on period, a periodicity of the on period, or a value of an inactivity timer. In some embodiments, the one or more metrics include (e.g., indicate, specify, describe, establish or configure) one or more traffic patterns on the connection. In some embodiments, the one or more traffic patterns include (e.g., indicate, specify, describe, identify, establish or configure) at least one of a buffer status, a channel quality indicator (CQI), a retransmission prediction, a traffic type, or a prediction of a physical downlink control channel (PDCCH) message or physical downlink shared channel (PDSCH) message. In some embodiments, the one or more metrics include one or more power or thermal metrics of a device including the wireless communication device. In some embodiments, the one or more power or thermal metrics include at least one of a battery level, a state of charge of a battery of the device, a rate of change of the battery level, a temperature, or a rate of change of the temperature of the device.

In yet another aspect, this disclosure is directed to a non-transitory computer readable medium storing instructions that, when executed by one or more processors, cause the one or more processors to establish a connection between the wireless communication device and a wireless communication node. The connection may be established according to a discontinuous reception (DRX) configuration defined by the wireless communication node. The DRX configuration may include/specify/define/indicate/describe an on period and a sleep period of a DRX cycle. The instructions may cause the one or more processors to determine one or more metrics of the wireless communication device or the connection. The instructions may cause the one or more processors to increase a duration of the sleep period within the DRX cycle of the connection according to the one or more metrics.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment, according to an example implementation of the present disclosure.

FIG. 5 is a block diagram of a system for performing adaptive wake-up signal (WUS) and/or connected-mode discontinuous reception (C-DRX) skipping, according to an example implementation of the present disclosure.

FIG. 6 is a block diagram of an example DRX cycle, according to an example implementation of the present disclosure.

FIG. 7 is a flow diagram of a method for performing adaptive wake-up signal (WUS) and connected-mode discontinuous reception (C-DRX) skipping, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present disclosure is directed to dynamic skipping of wake-up signal (WUS) and/or connected mode—discontinuous reception (C-DRX) on-duration. DRX is a power saving mechanism in which a device wakes up for a fixed amount of time to monitor for traffic, and goes to a low power state if there is no traffic. Some DRX configurations may include a WUS in which the device wakes up to listen for the WUS, which may indicate to the device that the device can skip the entire DRX on duration based on the WUS. In some instances, including certain channel conditions or configurations, traffic patterns, or battery states, it may not be beneficial for the device to always decode the WUS and/or remain on for the full duration of the C-DRX on-duration. Additionally, some cellular service or standards (e.g., LTE) are not configured to provide a WUS.

According to the systems and methods described herein, a device in an established DRX configuration (e.g., established or set between a device and a base station) may determine one or more metrics of the device and/or channel. The metrics may include channel conditions and configuration information, traffic patterns, and power/thermal levels. The device may increase a sleep duration within the negotiated/established DRX configuration based on the metrics. For example, the device may increase the sleep duration by skipping listening for or decoding a WUS, enter a sleep state at a time period during the on-duration or skipping the on-duration, and so forth. Such implementations may provide for power savings without having the device re-negotiate an updated DRX schedule or configuration with the base station.

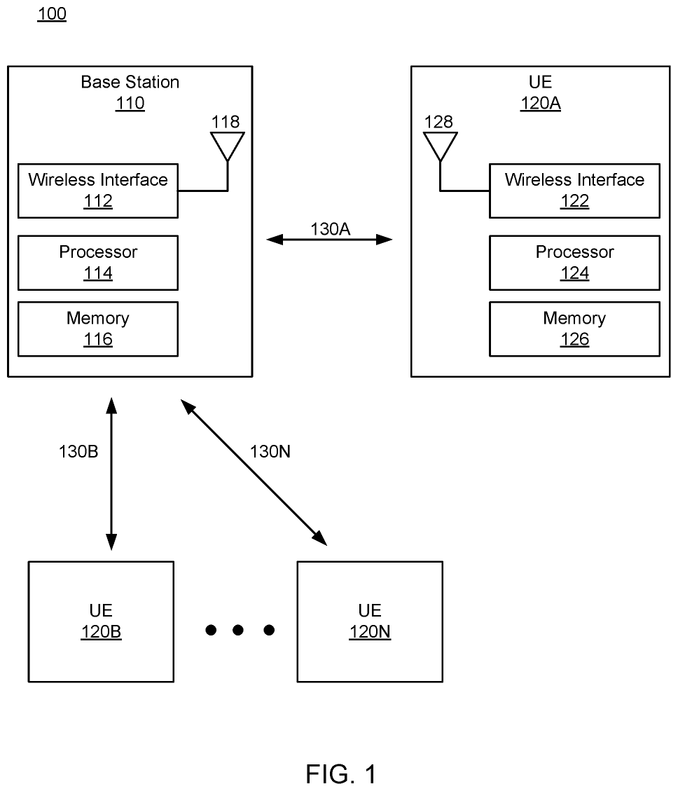

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130 (e.g., 130A, 130B, . . . 130N). The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110 and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding wireless communication link 130. For example, the UE 120 may transmit data to a base station 110 through a wireless communication link 130 and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0-1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126 and execute the instructions. In one aspect, the processor 124 may receive downconverted data at the baseband frequency from the wireless interface 122 and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency and encode or process the data. For example, the processor 124 may encode or process image data or audio data at the baseband frequency and provide the encoded or processed data to the wireless interface 122 for transmission.

The memory device 126 is a component that stores data. The memory device 126 may be embodied as random-access memory (RAM), flash memory, read-only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0-1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

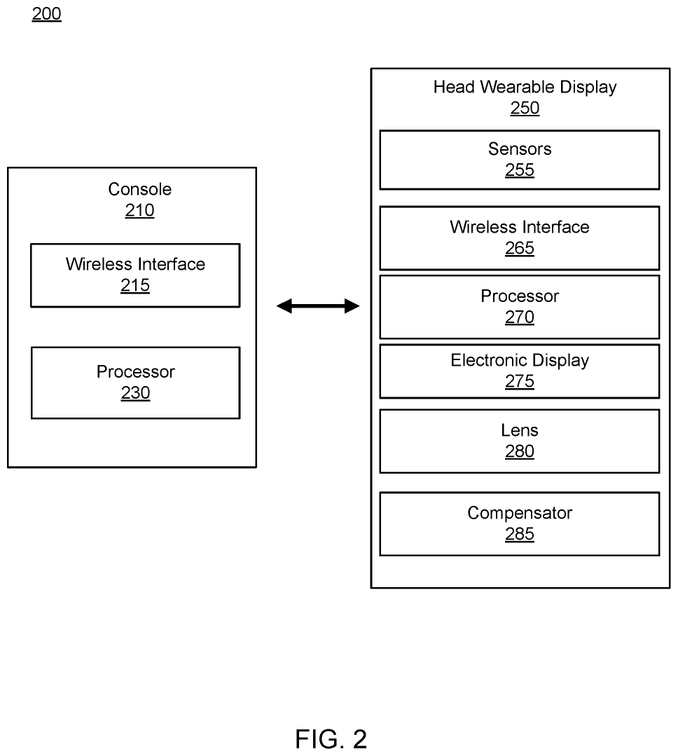

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to the image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

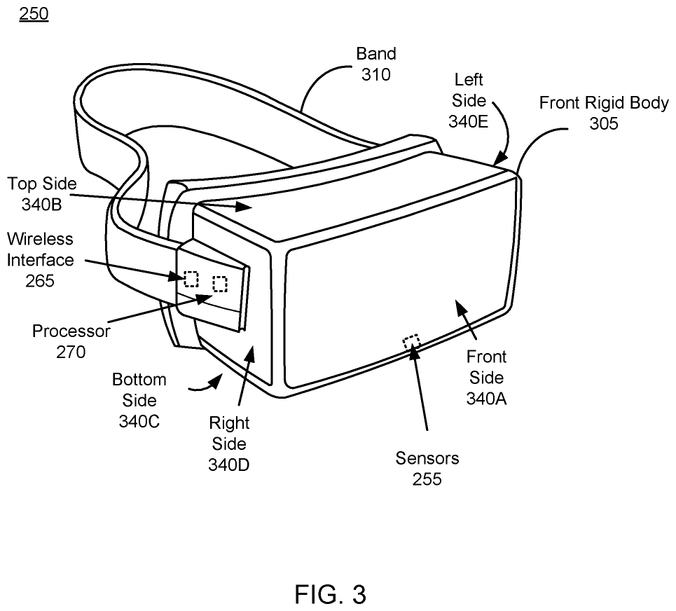

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

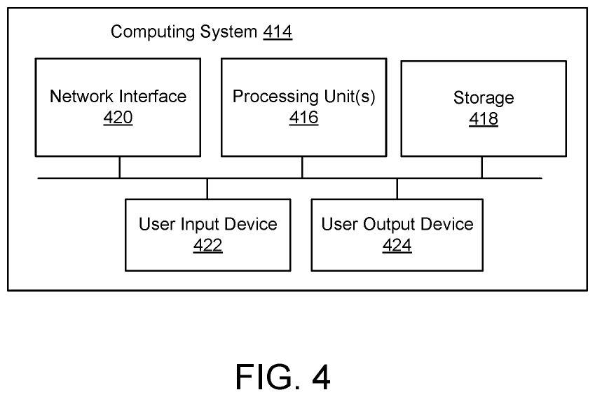

Various operations described herein can be implemented on computer systems. FIG. 4 shows a block diagram of a representative computing system 414 usable to implement the present disclosure. In some embodiments, the base station 110, the UE 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414. The computing system 414 can interpret the signals as indicative of particular user requests or information. The user input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

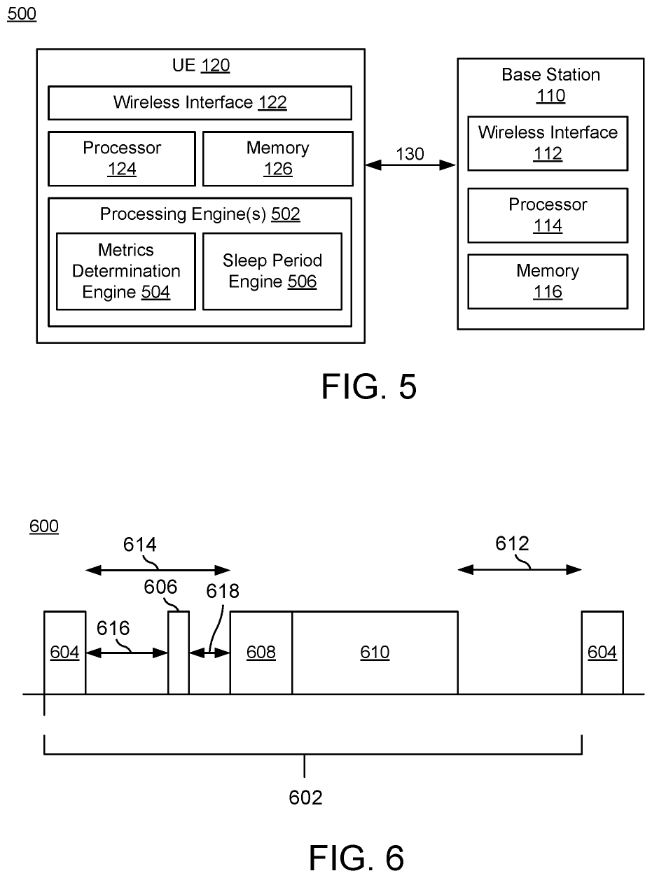

Referring generally to FIG. 5-FIG. 7, the present disclosure is directed to dynamic skipping of wake-up signal (WUS) and/or connected mode—discontinuous reception (C-DRX) on-duration. DRX is a power saving mechanism in which a device wakes up for a fixed amount of time to monitor for traffic, and goes to a low power state if there is no traffic. Some DRX configurations may include a WUS in which the device wakes up to listen for the WUS, which may indicate to the device that the device can skip the entire DRX on duration based on the WUS. In some instances, including certain channel conditions or configurations, traffic patterns, or battery states, it may not be beneficial for the device to always decode the WUS and/or remain on for the full duration of the C-DRX on-duration. Additionally, some cellular service or standards (e.g., LTE) may not be configured to provide a WUS.

According to the systems and methods described herein, a device in an established DRX configuration (e.g., established or set between a device and a base station) may determine one or more metrics of the device and/or channel. The metrics may include channel conditions and configuration information, traffic patterns, and power/thermal levels. The device may increase a sleep duration within the negotiated/established DRX configuration based on the metrics. For example, the device may increase the sleep duration by skipping listening for or decoding a WUS, enter a sleep state at a time period during the on-duration or skipping the on-duration, and so forth. Such implementations may provide for power savings without having the device re-negotiate an updated DRX schedule or configuration with the base station.

Referring to FIG. 5, a block diagram of a system 500 for performing adaptive wake-up signal (WUS) and/or connected-mode discontinuous reception (C-DRX) skipping is shown, according to an example implementation of the present disclosure. The system 500 may include a UE 120 and a base station 110. The UE 120 and base station 110 may be similar to the UE 120 and base station 110 described above with reference to FIG. 1. In particular, the base station 110 and the UE 120 may include respective wireless interfaces 112, 122, respective processors 114, 124, and respective memory 126. As described in greater detail below, the UE 120 may be configured to establish a connection 130 (e.g., similar to the wireless communication links 130 described above) between the UE 120 and base station 110. The UE 120 may be configured to establish the connection 130 according to a discontinuous reception (DRX) configuration defined by the base station 110 to include an on period and a sleep period of a DRX cycle. The UE 120 may be configured to determine one or more metrics of the wireless communication device and/or the connection 130. The UE 120 may be configured to increase a duration of the sleep period within the DRX cycle of the connection, according to the one or more metrics.

The UE 120 may include one or more processing engine(s) 502. The processing engine(s) 502 may include any device, component, element, or hardware designed or configured to perform various functions, steps, or processes described herein. In some embodiments, the processing engine(s) 502 may include processor(s) 124 configured by or executing corresponding instructions (e.g., stored in memory 126) to perform the various processes/functions/steps described herein. The processing engine(s) 502 may include a metrics determination engine 504 and a sleep period engine 506. As described in greater detail below, the metrics determination engine 504 may be configured to determine, detect, measure, or otherwise identify one or more metrics of the UE 120 and/or the connection 130. The sleep period engine 506 may be configured to modify, adapt, configure, increase, decrease, change, or otherwise adjust a sleep period within the DRX cycle, according to the metrics identified by the metrics determination engine 504.

The UE 120 may include a metrics determination engine 504. The metrics determination engine 504 may be designed or configured to determine, detect, measure, or otherwise identify one or more metrics of the UE 120 and/or the connection 130. In some embodiments, the metrics determination engine 504 may be configured to identify one or more metrics of the UE 120. The metrics of the UE 120 may include, for example, one or more power or thermal metrics of the UE 120. In some embodiments, the metrics determination engine 504 may be configured to identify one or more metrics of the connection 130. The metrics of the connection 130 may include, for example, configuration information of the DRX configuration defined by the wireless communication node and/or the traffic pattern(s) of the connection. As described in greater detail below, the UE 120 may be configured to modify a sleep period of the DRX cycle, according to the metrics determined by the metrics determination engine 504.

The metrics determination engine 504 may be configured to identify or determine one or more metrics of the UE 120. As noted above, the metrics of the UE 120 may include, for instance, power and/or thermal metrics of the UE 120. In some embodiments, the metrics determination engine 504 may be configured to identify the power and/or thermal metrics based on data from one or more sensors. For example, the metrics determination engine 504 may be configured to receive data from one or more temperature and/or battery sensor(s) of the UE 120, to identify or determine the power and/or thermal metrics. The power metrics may include, for example, a battery level, a state of charge of the battery, a rate of change of the battery level, etc. The thermal metrics may include, for example, a current temperature of the UE 120 (e.g., the battery or another surface/component of the UE 120), a rate of change of temperature of the UE 120, etc. The metrics determination engine 504 may be configured to determine the power and/or thermal metrics based on data from the sensor(s) of the UE 120.

The metrics determination engine 504 may be configured to identify and/or determine one or more metrics corresponding to traffic patterns of the connection 130. The traffic patterns may include, for example, a buffer status, a channel quality indicator (CQI), a retransmission prediction, a traffic type, and/or a prediction of a physical downlink control channel (PDCCH) or physical downlink shared channel message (PDSCH) message. The metrics determination engine 504 may be configured to determine the buffer status based on an amount of information/data packets included or otherwise maintained in a buffer of the UE 120. The metrics determination engine 504 may be configured to determine the CQI based on measured characteristics of the connection (e.g., received signal strength indicator, signal-to-noise ratio, error or packet drop rates, etc.). The metrics determination engine 504 may be configured to determine a retransmission prediction based on successful or unsuccessful acknowledgements from the base station 110. The metrics determination engine 504 may be configured to determine the traffic type based on the application or resource executing on the UE 120 and using the connection 130, based on whether the traffic is periodic (such as voice or sensor traffic) or aperiodic (such as burst traffic), and so forth. The metrics determination engine 504 may be configured to predict a PDCCH message from the base station 110, for example, after the UE 120 requests a resource allocation (like uplink resources to send data), a PDCCH message containing the grant or denial of that request is likely to be received from the base station 110. Similarly, if the UE 120 is expecting a downlink data transmission (like an incoming call or data packet), the metrics determination engine 504 may predict a PDCCH message will/may be received from the base station 110 indicating how the data will/may be sent over the PDSCH. The metrics determination engine 504 may be configured to predict a PDSCH message responsive to receiving a scheduling grant on the PDCCH which allocates resources for downlink data on the PDSCH in the allocated time-frequency resources.

Referring now to FIG. 5 and FIG. 6, the metrics determination engine 504 may be configured to determine one or more metrics corresponding to the DRX configuration defined by the base station 110. Specifically, FIG. 6 shows a timing diagram 600 of an example DRX cycle 602, according to an example implementation of the present disclosure. As shown in FIG. 6, the DRX cycle 602 may include a wake-up signal 604, followed by a synchronization signal block (SSB) 606, an on duration 608, an inactivity timer 610, and a sleep period 612. The timing of transmission of the wake-up signal 604, SSB 606, as well as the on duration 608, inactivity timer 610, and sleep period 612 may each be configured by the base station 110 as part of the DRX configuration. In this regard, the DRX configuration may be set or defined by the base station 110.

The wake-up signal 604 may include a signal sent by the base station 110 to the UE 120, to cause the UE to exit a sleep state and enter an active state. During the sleep (or idle, inactive, low-power) state, the UE 120 may not actively monitor the connection 130 for data from the base station 110. In the active state, the UE 120 may actively monitor the connection 130 for data from the base station 110. The SSB 606 may be or include a primary synchronization signal (PSS) and secondary synchronization signal (SSS) sent by the base station 110 and used by the UE 120 to detect the network connection, establish time synchronization, and/or identify the specific cell in which the UE 120 is connected. The SSB 606 may be broadcast periodically by the base station 110, and may be received at a time interval after receiving the wake-up signal 604. The on duration 608 may be or include a period of time following the wake-up signal 604, in which the receiver of the UE 120 (e.g., the receiver of the antenna 128 of the UE 120) is activated to identify any incoming signals. The inactivity timer 610 may be or include a duration of time after the on duration 608 in which the UE 120 remains in a sleep state prior to transitioning to the sleep period 612.

The UE 120 may include a sleep period engine 506. The sleep period engine 506 may be designed or configured to modify, adapt, configure, increase, decrease, change, or otherwise adjust a sleep period within the DRX cycle 602. In some embodiments, the sleep period engine 506 may be configured to adjust the sleep period within the DRX cycle 602, by selectively skipping decoding of the wake-up signal 604 and/or by switching the device to a sleep mode during a portion of (or for the entirety of) the on duration 608 of the DRX cycle 602. The sleep period engine 506 may be configured to adjust the sleep period within the DRX cycle 602, according to the metrics identified by the metrics determination engine 504.

The sleep period engine 506 may be configured to adjust the sleep period within the DRX cycle 602, according to one or more metrics relating to configuration information of the DRX configuration. In some embodiments, the sleep period engine 506 may increase the sleep period within the DRX cycle 602 according to the periodicity of the on duration 608 of the DRX cycle. For example, if no periodic traffic pattern is anticipated during the on duration 608, the sleep period engine 506 may be configured to increase the sleep period within the DRX cycle 602. In other words, if the metrics determination engine 504 detects an aperiodic traffic pattern anticipated during the on duration 608, the sleep period engine 506 may increase the sleep period.

The sleep period engine 506 may be configured to adjust the sleep period within the DRX cycle 602, according to one or more metrics relating to traffic patterns of the connection 130. In some embodiments, the sleep period engine 506 may increase the sleep period within the DRX cycle 602 according to an anticipation of a PDCCH and/or a PDSCH message. For example, if the metrics determination engine 504 does not predict that the base station 110 is to send a PDCCH message via the connection 130, the metrics determination engine 504 may instruct the sleep period engine 506 to increase the sleep period within the DRX cycle 602 because the UE 120 is not expected to miss a PDCCH message during the increased sleep period. Similarly, if the metrics determination engine 504 does not predict that the base station 110 is to send a PDSCH message via the connection 130, the metrics determination engine 504 may instruct the sleep period engine 506 to increase the sleep period within the DRX cycle 602 because the UE 120 is not expected to miss a PDSCH message during the increased sleep period.

The sleep period engine 506 may be configured to adjust the sleep period within the DRX cycle 602, according to one or more metrics relating to the power or thermal levels of the UE 120. For example, if the battery level recorded by the one or more battery sensors of the UE 120 indicates a depleted battery level, the sleep period engine 506 may be configured to increase the sleep period within the DRX cycle 602. In some embodiments, the depleted battery level may be determined by the metrics determination engine 504. The metrics determination engine 504 may compare the battery level received from the one or more battery sensors of the UE 120 to a threshold battery level stored by the metrics determination engine 504. In some embodiments, the threshold battery level may be a battery level required in order for the UE 120 to operate for a predetermined duration of time (e.g., 30 minutes). Upon determining that the battery level received from the one or more battery sensors of the UE 120 falls below the threshold battery level, the metrics determination engine 504 may instruct the sleep period engine 506 to increase the duration of the sleep period within the DRX cycle in order to preserve battery consumption. As another example, the sleep period engine 506 may be configured to increase the sleep period within the DRX cycle 602 in response to a current temperature of the UE 120, received from the one or more temperature sensors of the UE 120, being greater than a threshold temperature. In some embodiments, the threshold temperature may be a temperature beyond which the UE 120 fails to operate. The metrics determination engine 504 may receive the current temperature of the UE 120 and, upon comparing the current temperature to the threshold temperature, instruct the sleep period engine 506 to increase the duration of the sleep period within the DRX cycle if the current temperature is greater than the threshold temperature.

The sleep period engine 506 may be configured to adjust the sleep period within the DRX cycle 602, by selectively skipping decoding the wake-up signal 604. For example, upon receiving the wake-up signal 604, the sleep period engine 506 may be configured to skip/bypass decoding the wake-up signal 604. Rather, the sleep period engine 506 may be configured to cause the UE 120 to discard, ignore, or otherwise disregard the wake-up signal (and instead sleep through the wake-up period in which the wake-up signal 604 is received and decoded). By skipping decoding of the wake-up signal 604, the sleep period engine 506 increases the sleep period within the DRX cycle 602 to include sleep period 614, as shown in FIG. 6. The sleep period 614 illustrates the additional sleep period within the DRX cycle 602 resulting from skipping decoding of the wake-up signal 604.

The sleep period engine 506 may be configured to adjust the sleep period within the DRX cycle 602, by switching from the active (or “on”) state of the DRX cycle 602 to the sleep period prior to the set time configured according to the DRX configuration set by the base station 110. For example, the sleep period engine 506 may enter the sleep state through the inactivity timer 610, for a portion (or all) of the on duration 608, by skipping decoding the SSB 606 or wake-up signal 604, and so forth.

In some embodiments, the sleep period engine 506 may be configured to adjust the sleep period within the DRX cycle 602, by switching from the sleep state of the DRX cycle 602 to an active (or on period) within the DRX cycle 602. For example, as an alternative implementation to the systems and methods described herein, the sleep period engine 506 may be configured to decrease the sleep duration, in response to/based on/according to the metrics identified by the metrics determination 602 indicating, e.g., an expected message or periodic traffic from the base station 110, power or thermal levels satisfying a threshold criteria (e.g., power over an upper threshold, temperature within a predetermined range of operating temperatures), and so forth. In this regard, by switching from the active state to the sleep state of the DRX cycle 602 and vice versa, the sleep period engine 506 adjusts the sleep period within the DRX cycle 602 to include sleep period 618, as shown in FIG. 6.

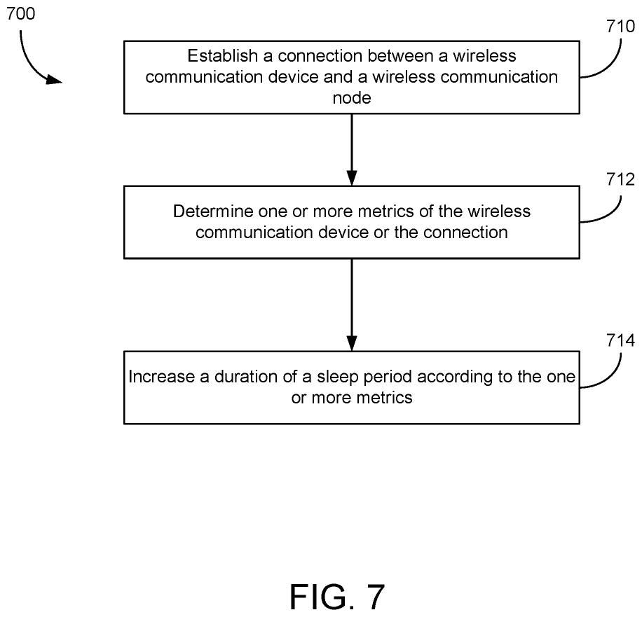

Referring now to FIG. 7, a flow diagram of a method 700 for performing adaptive wake-up signal (WUS) and connected-mode discontinuous reception (C-DRX) skipping is shown. In some embodiments the method 700 begins when a wireless communication device (e.g., the UE 120) establishes a connection 130 between the UE 120 and a wireless communication node (e.g., base station 110), at step 710. For example, the connection 130 may established upon an activation of the UE 120. The activation of the UE 120 may occur when a user of the UE 120 accesses an application which is to send or receive data from a base station 110, responsive to the antenna or wireless interface of the UE 120 being turned on or activated, etc. Alternatively or additionally, the connection 130 may be established responsive to the UE 120 attempting to camp on a cell and frequency of the base station 110.

The connection 130 may be established according to a discontinuous reception (DRX) configuration defined by the base station 110, as described above. In some embodiments, the DRX configuration includes (e.g., indicates, specifies, identifies, establishes or configures) a wake-up signal (WUS) period. The WUS period may refer to a duration of time during which the UE 120 listens for or otherwise receives a WUS from the base station 110.

In some embodiments, the DRX configuration includes (e.g., indicates, specifies, identifies, establishes or configures) an on period (e.g., an activated period) and a sleep period of a DRX cycle. The on period of the DRX cycle may refer to a duration of time during the DRX cycle in which the wireless transceiver 128 of the UE 120 is activated and listening for messages/signals/information from the base station 110. The sleep period of the DRX cycle may refer to a duration of time during the DRX cycle in which the UE 120 (e.g., the wireless transceiver 128 of the UE 120) is inactive (e.g., asleep, idle, etc.).

Once the connection has been established, at step 710, the UE 120, being in the established DRX configuration, may determine one or more metrics of the UE 120 and/or the connection 130, at step 712. In some embodiments, the metrics determination engine 504 may determine the one or more metrics, as described above. The one or more metrics may include configuration information of the DRX configuration, one or more traffic patterns on the connection 130, and one or more power or thermal metrics of a device including the UE 120.

The configuration information of the DRX configuration may include at least one of a first duration between a wake-up signal (WUS) period and the on period of the DRX cycle, a second duration of the WUS period, a third duration of the on period, a periodicity of the on period, and/or a value of an inactivity timer. The first duration between the WUS period and the on period of the DRX cycle may refer to a period of time that passes between when the UE 120 detects the WUS 604 and when the on duration 608 of the DRX cycle begins (e.g., represented by 614 in FIG. 6). The second duration of the WUS period may refer to a period of time during which the UE 120 listens for the WUS 604 from the base station 110. The third duration of the on period (e.g., the on duration 608) may refer to a period of time following the WUS 604, in which the receiver of the UE 120 (e.g., the receiver of the antenna 128 of the UE 120) is activated to identify any incoming signals. The periodicity of the on period may refer to a pattern of activity anticipated during the on period of the DRX cycle 602 (e.g., a periodic pattern of activity, an aperiodic pattern of activity). The value of the inactivity timer may refer to an amount of time recorded by the inactivity timer 610 after the third duration of the on period in which the UE 120 remains in an active or idle state prior to transitioning to the sleep period 612. Such metrics may be indicative of an amount or duration of a deep sleep state in which the UE 120 may enter. For example, where each period is separated by a relatively similar amount of time, the UE 120 may repeatedly be entering a doze and awake state, thereby never entering a deep sleep mode.

The one or more traffic patterns may include at least one of a buffer status, a channel quality indicator (CQI), a retransmission prediction, a traffic type, or a prediction of a physical downlink control channel (PDCCH) message or physical downlink shared channel (PDSCH) message. The buffer status may refer to an amount of information/data packets included or otherwise maintained in a buffer of the UE 120. The CQI may refer to a score determined by the metrics determination engine 504 based on the one or more measured characteristics of the connection 130 (e.g., received signal strength indicator, signal-to-noise ratio, error or packet drop rates, etc.). The retransmission prediction may refer to a prediction of whether the traffic may be successfully transmitted via the connection 130 based on successful or unsuccessful acknowledgements from the base station 110. The traffic type may refer to particular traffic from an application or a resource executing on the UE 120 and using the connection 130, whether the traffic is periodic or aperiodic, and so forth. The prediction of the PDCCH message or the PSCH message can refer to whether the UE 120 expects to receive at least one of the PDCCH message or the PDSCH message from the base station 110, as described above.

The one or more power or thermal metrics may include at least one of a battery level, a state of charge of a battery of the device, a rate of change of the battery level, a temperature, or a rate of change of the temperature of the device. In some embodiments, the metrics determination engine 504 may receive data from one or more temperature and/or battery sensor(s) of the UE 120 to identify or determine the power and/or thermal metrics. The one or more battery sensor(s) of the UE 120 may be configured to measure/detect the battery level, the state of charge of the battery, the rate of change of the battery level, etc. The one or more temperature sensor(s) of the UE 120 may measure, for example, the current temperature of the UE 120 (e.g., the battery or another surface/component of the UE 120), the rate of change of temperature of the UE 120, etc.

Once the metrics determination engine 504 has determined the one or more metrics, at step 712, the UE 120 increases a duration of the sleep period within the DRX cycle, at step 714. In some embodiments, the sleep period engine 506, as described above, may increase the duration of the sleep period within the DRX cycle according to the one or more metrics determined by the metrics determination engine 504 at step 712. The increased duration of the sleep period may be achieved by skipping a portion or an entirety of the DRX on period. In some embodiments, the increased duration of the sleep period may be achieved by skipping the decoding of the WUS.

In some embodiments, the sleep period engine 506 increases the duration of the sleep period within the DRX cycle 602 according to one or more metrics relating to the configuration information of the DRX configuration. For example, the sleep period engine 506 may skip waking up for at least a portion or an entirety of the on period of the DRX cycle when there are no activities (e.g., search, measurement, maintenance, etc.) scheduled during the on period. As another example, when the first duration between the WUS and the on period is large, the sleep period engine 506 may skip waking up to decode the WUS in order to enter a deeper sleep mode during the large first duration.

In some embodiments, the sleep period engine 506 increases the duration of the sleep period within the DRX cycle 602 according to the one or more metrics relating to traffic patterns of the connection 130. For example, if the CQI and/or the retransmission prediction indicate that the connection 130 is weak and/or that the UE 120 may not be able to successfully communicate with the base station 110, the sleep period engine 506 may increase the duration of the sleep period within the DRX cycle 602. As another example, if the one or more traffic patterns are aperiodic (e.g., bursty traffic), the sleep period engine 506 may skip WUS decoding.

In some embodiments, the sleep period engine 506 increases the duration of the sleep period within the DRX cycle 602 according to one or more metrics relating to the power or thermal levels of the UE 120. For example, in a battery depleted state, the sleep period engine 506 may be configured to increase the duration of the sleep period within the DRX cycle, as described above. As another example, when a current temperature of the sleep period engine 506 is higher than a threshold temperature, the sleep period engine 506 may be configured to increase the duration of the sleep period within the DRX cycle 602.

In some embodiments, the UE maintains a sleep mode during the WUS period according to the one or more metrics. Alternatively or additionally, the UE 120 may switch to the sleep mode during a portion of the on period of the DRX cycle according to the one or more metrics. For example, the UE 120 may skip a portion of the on period of the DRX cycle if the UE 120 determines that the transmission/reception portion activity is complete and that no new activity is possible for the remainder of the on period and inactivity timer durations of the DRX cycle. Alternatively or additionally, the UE 120 may switch to the sleep mode for a full duration of the on period of the DRX cycle according to the one or more metrics. For example, if there are no active applications running on the UE 120, the UE may identify an absence of traffic and may skip waking up for the entirety of the on period of the DRX cycle.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
establishing, by a wireless communication device, a connection between the wireless communication device and a wireless communication node, the connection established according to a discontinuous reception (DRX) configuration defined by the wireless communication node, the DRX configuration comprising an on period and a sleep period of a DRX cycle;
determining, by the wireless communication device, one or more metrics of the wireless communication device or the connection; and
increasing, by the wireless communication device, a duration of the sleep period within the DRX cycle of the connection according to the one or more metrics.

2. The method of claim 1, wherein the DRX configuration comprises a wake-up signal (WUS) period in which the wireless communication device is to listen for a WUS from the wireless communication node, wherein increasing the duration of the sleep period comprises:
maintaining, by the wireless communication device, a state of the wireless communication device in a sleep mode during the WUS period according to the one or more metrics.

3. The method of claim 1, wherein increasing the duration of the sleep period comprises:
switching, by the wireless communication device, a state of the wireless communication device to a sleep mode during a portion of the on period of the DRX cycle according to the one or more metrics.

4. The method of claim 1, wherein increasing the duration of the sleep period comprises:
switching, by the wireless communication device, a state of the wireless communication device to a sleep mode for a full duration of the on period of the DRX cycle according to the one or more metrics.

5. The method of claim 1, wherein the one or more metrics comprise configuration information of the DRX configuration.

6. The method of claim 5, wherein the configuration information of the DRX configuration comprise at least one of a first duration between a wake-up signal (WUS) period and the on period of the DRX cycle, a second duration of the WUS period, a third duration of the on period, a periodicity of the on period, or a value of an inactivity timer.

7. The method of claim 1, wherein the one or more metrics comprise one or more traffic patterns on the connection.

8. The method of claim 7, wherein the one or more traffic patterns comprise at least one of a buffer status, a channel quality indicator (CQI), a retransmission prediction, a traffic type, or a prediction of a physical downlink control channel (PDCCH) message or physical downlink shared channel (PDSCH) message.

9. The method of claim 1, wherein the one or more metrics comprise one or more power or thermal metrics of a device comprising the wireless communication device.

10. The method of claim 9, wherein the one or more power or thermal metrics comprise at least one of a battery level, a state of charge of a battery of the device, a rate of change of the battery level, a temperature, or a rate of change of the temperature of the device.

11. A wireless communication device, comprising:
one or more processors configured to:
establish a connection between the wireless communication device and a wireless communication node, the connection established according to a discontinuous reception (DRX) configuration defined by the wireless communication node, the DRX configuration comprising an on period and a sleep period of a DRX cycle;
determine one or more metrics of the wireless communication device or the connection; and
increase a duration of the sleep period within the DRX cycle of the connection according to the one or more metrics.

12. The wireless communication device of claim 11, wherein the DRX configuration comprises a wake-up signal (WUS) period in which the wireless communication device is to listen for a WUS from the wireless communication node, wherein increasing the duration comprises:
maintaining a state of the wireless communication device in a sleep mode during the WUS period according to the one or more metrics.

13. The wireless communication device of claim 11, wherein increasing the duration of the sleep period comprises:
switching a state of the wireless communication device to a sleep mode during a portion of the on period of the DRX cycle according to the one or more metrics; or
switching the state of the wireless communication device to the sleep mode for a full duration of the on period of the DRX cycle according to the one or more metrics.

14. The wireless communication device of claim 11, wherein the one or more metrics comprise configuration information of the DRX configuration.

15. The wireless communication device of claim 14, wherein the configuration information of the DRX configuration comprise at least one of a first duration between a wake-up signal (WUS) period and the on period of the DRX cycle, a second duration of the WUS period, a third duration of the on period, a periodicity of the on period, or a value of an inactivity timer.

16. The wireless communication device of claim 11, wherein the one or more metrics comprise one or more traffic patterns on the connection.

17. The wireless communication device of claim 16, wherein the one or more traffic patterns comprise at least one of a buffer status, a channel quality indicator (CQI), a retransmission prediction, a traffic type, or a prediction of a physical downlink control channel (PDCCH) message or physical downlink shared channel (PDSCH) message.

18. The wireless communication device of claim 11, wherein the one or more metrics comprise one or more power or thermal metrics of a device comprising the wireless communication device.

19. The wireless communication device of claim 18, wherein the one or more power or thermal metrics comprise at least one of a battery level, a state of charge of a battery of the device, a rate of change of the battery level, a temperature, or a rate of change of the temperature of the device.

20. A non-transitory computer readable medium storing instructions that, when executed by one or more processors, cause the one or more processors to:
establish, by a wireless communication device, a connection between the wireless communication device and a wireless communication node, the connection established according to a discontinuous reception (DRX) configuration defined by the wireless communication node, the DRX configuration comprising an on period and a sleep period of a DRX cycle;
determine, by the wireless communication device, one or more metrics of the wireless communication device or the connection; and
increase, by the wireless communication device, a duration of the sleep period within the DRX cycle of the connection according to the one or more metrics.
